(19) United States
(12) Patent Application Publication
(10) Pub. No.: US 2020/0342488 A1
(43) Pub. Date: Oct. 29, 2020

(54) AUTOMATED OFFER MANAGEMENT

(71) Applicant: eBay Inc., San Jose, CA (US)

(72) Inventors: Kiran Kanchamreddy, Milpitas, CA (US); Muthuramalingam Sundaresan, Fremont, CA (US); Yoni Acriche, Austin, TX (US)

(21) Appl. No.: 16/391,948

(22) Filed: Apr. 23, 2019

(51) Int. Cl. G06Q 30/02

(52) U.S. Cl. CPC G06Q 30/0235; G06Q 30/0239; G06Q 30/0224; G06Q 30/0222

(57) ABSTRACT

Disclosed are systems, methods, and non-transitory computer-readable media for automated offer management. An offer management system determines predetermined affinity signals indicating respective candidate user interest in purchasing an item listed for sale on an online marketplace. The offer management system determines tiers of candidate users based on the affinity signals. Each tier includes a subset of the candidate users. In response to determining that a threshold period of time has elapsed, the offer management system transmits a first offer in relation to the item listed for sale to candidate users in the first tier of candidate users. The first offer includes an first offer price that is a deviation from the sale price of the item.

### TECHNICAL FIELD

An embodiment of the present subject matter relates generally to generating electronic offers and, more specifically, to automated offer management.

### BACKGROUND

Online marketplace services allow users to buy and sell items. For example, these services enable users to post listings for each item that the user wishes to sell, as well as view listings posted by other users. Some online marketplace service may allow a user to generate offers for items that the user has listed on the online marketplace. The offer may indicate an alternate price at which a potential buyer may purchase the item. This process can be particularly laborious when a user has multiple items listed for sale as a user has to identify users to provide the offers to, as well as generate each offer individually. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2. is a block diagram of an offer management system, according to some example embodiments.

FIGS. 3A-3C show examples of offers that are automatically generated by an offer management system, according to some example embodiments.

FIG. 4 is a flowchart showing an example method of automatically generating offers for an item, according to certain example embodiments.

FIG. 5 is a flowchart showing an example method of generating and transmitting offers including multiple sale prices, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for automated offer management. An offer management system automatically generates and transmits offers for an item listed for sale on an online marketplace. The offers are transmitted to users identified to be potentially interested in the item listed for sale. Each offer includes a deviated price for the item listed for sale that is different than the price included in the listing for the item on the online marketplace. For example, the deviated price may be lower or higher than the price included in the listing on the online marketplace. A user may accept the offer to pay the deviated price to purchase the item.

The offer management system may transmit the offer in phases to various tiers of candidate users. Each tier of candidate users is determined by the offer management system based on an estimated level of interest of the candidate users in purchasing the item. For example, the offer management system may initially provide the offer to a first tier of candidate users estimated to have the highest level of interest in purchasing the item. If a predetermined period of time passes without the initial offer being accepted, the offer management system may transmit a subsequent offer to a second tier of candidate users estimated to have a level of interest in purchasing the item that is lower the level of interest estimated for the candidate users in the first tier. The subsequent offer may include a different deviated price than the deviated price included in the initial offer. For example, the deviated price in the subsequent offer may be lower or higher than the deviated price in the initial offer.

The offer management system determines the tiers of candidate users based on affinity signals indicating each candidate user's level of interest in purchasing the item. Affinity signals may be any type of data indicating a user's interest in a product. For example, an affinity signal may be based on the user's previous interactions with the item and/or similar items on the online marketplace, such as the user viewing the listing for the item, viewing listings for similar items, liking the item, adding the item to their shopping cart, following the item, etc. Affinity signals may also be based on affinity data provided by the user indicating items, categories, of items, etc., that the user is interested in, likes, dislikes, etc. Affinity signals may also be based on search results provided by the user, such as the user having submitted search queries that provided results for the same or similar item.

The offer management system may use the gathered affinity signals for each candidate user to determine an affinity score indicating the respective candidate user's level of interest in purchasing the item. The offer management system may then rank the candidate users based on the affinity scores and generate the tiers of candidate users based on the ranking. The functionality of the offer management system is described in greater detail in the following discussion and the corresponding figures.

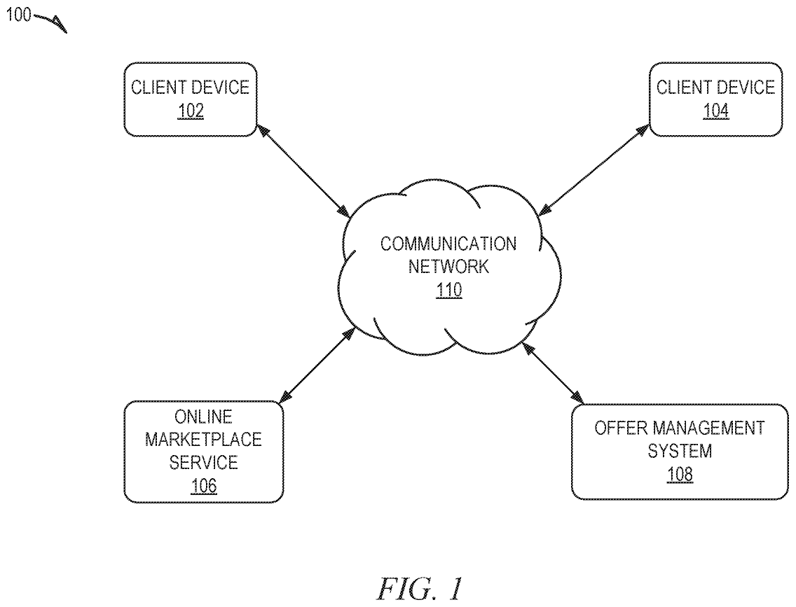

FIG. 1 shows an example system 100, wherein electronic devices communicate via a network for purposes of exchanging content and other data. As shown, multiple devices (i.e., client device 102, client device 104, online marketplace service 106, and offer management system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

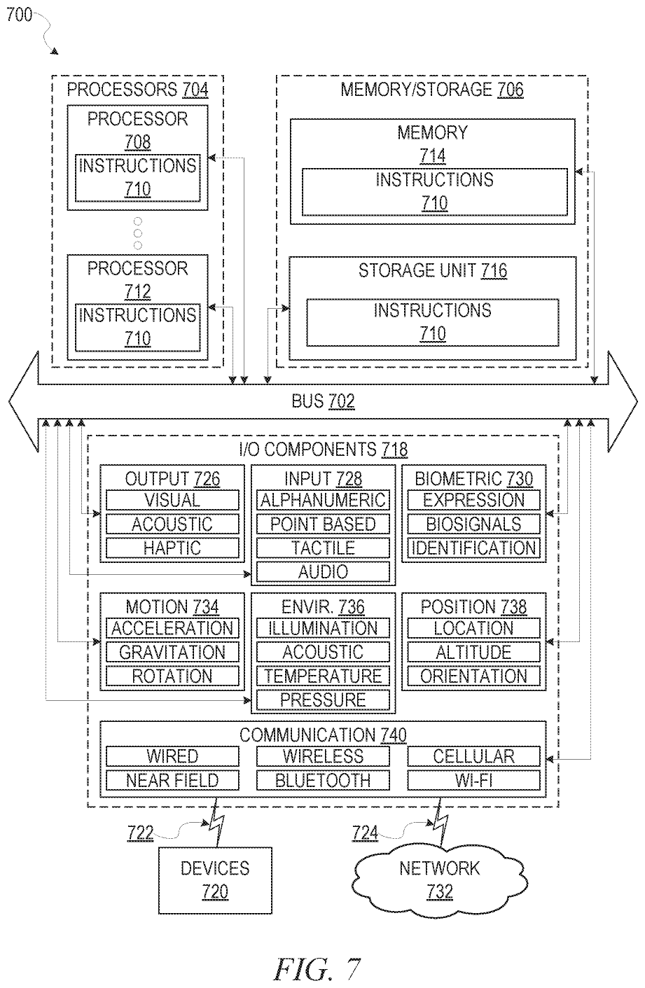

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106. The online marketplace service 106 provides an online marketplace in which users may post items for sale and purchase items posted for sale by other users. For example, the online marketplace service 160 may include items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) in which users may post items for sale and purchase items posted for sale by other users. For example, the online marketplace service 106 provides a user interface in which users may view item listings posted to the online marketplace service 106. Each item listing provides details for an item or items listed for sale. For example, the item listing may include an item description, images, sale price, current bid price, auction time remaining, etc.

The online marketplace service 106 may further provide functionality that enables a user to purchase and/or bid on an item. For example, the online marketplace service 106 may provide user interface elements (e.g., button, text fields, etc.) that a user may use to select purchase an item, place a bid, etc., as well as provide their financial (e.g., credit card number, bank account number) and personal information (e.g., shipping address, billing address, etc.) to complete the purchase.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace. The online marketplace service 106 provides users with a listing interface that enables a user to create a new listing as well as provide data for the listing. For example, the listing interface may include data fields that prompt the user to provide specified information for the listing, such as the price, description, etc. The listing interface may also include user interface elements, such as buttons, that enable the user to submit and/or post a completed listing. That is, the user may post the listing after the user has filled in the data fields included in the listing interface.

The online marketplace service 106 also enables a user to transmit direct offers to potential buyers to purchase an item that the user has listed for sale on the online marketplace. For example, a user may transmit an offer with a reduced sale price to a potential buyer that has expressed interest in the item in an attempt to entice the user to purchase the item. Manually generating a sending these offers can be laborious, particularly if the user has multiple items listed for sale and/or would like to send multiple offers. Additionally, sellers often do not know which buyers have expressed interest in their items (e.g., due to data accessibility issues) and thus do not know which buyers should receive offers. To alleviate this issue, the online marketplace service 106 utilizes the functionality of the offer management system 108, which provides for automated management of offer generation, transmission, acceptance, etc.

The offer management system 108 automatically generates and transmits offers for an item listed for sale on the online marketplace. The offers are transmitted to users identified by the offer management system 108 as being potentially interested in the item listed for sale. Each offer includes a deviated price for the item listed for sale that is different than the price included in the listing for the item on the online marketplace. For example, the deviated price may be lower or higher than the price included in the listing on the online marketplace. A user may accept the offer to pay the deviated price to purchase the item.

The offer management system 108 may transmit the offer in phases to various tiers of candidate users. Each tier of candidate users is determined by the offer management system 108 based on estimated levels of interest of the candidate users in purchasing the item. For example, the offer management system 108 may initially transmit an offer to a first tier of candidate users estimated to have the highest level of interest in purchasing the item. If a predetermined period of time passes without the initial offer being accepted, the offer management system 108 may transmit a subsequent offer to a second tier of candidate users estimated to have a level of interest in purchasing the item that is lower the level of interest estimated for the candidate users in the first tier. The subsequent offer may include a different deviated price than the deviated price included in the initial offer. For example, the deviated price in the subsequent offer may be lower or higher than the deviated price in the initial offer.

The offer management system 108 determines the tiers of candidate users based on affinity signals indicating each candidate user's level of interest in purchasing the item. Affinity signals may be any type of data indicating a user's interest in a product. For example, an affinity signal may be based on the user's previous interactions with the item and/or similar items on the online marketplace, such as the user viewing the listing for the item, viewing listings for similar items, liking the item, adding the item to their shopping cart, following the item, etc. Affinity signals may also be based on affinity data provided by the user indicating items, categories, of items, etc., that the user is interested in, likes, dislikes, etc. Affinity signals may also be based on search results provided by the user, such as the user having submitted search queries that provided results for the same or similar item.

The offer management system 108 may use the gathered affinity signals for each candidate user to determine an affinity score indicating the respective candidate user's level of interest in purchasing the item. The offer management system 108 may then rank the candidate users based on the affinity scores and generate the tiers of candidate users based on the ranking.

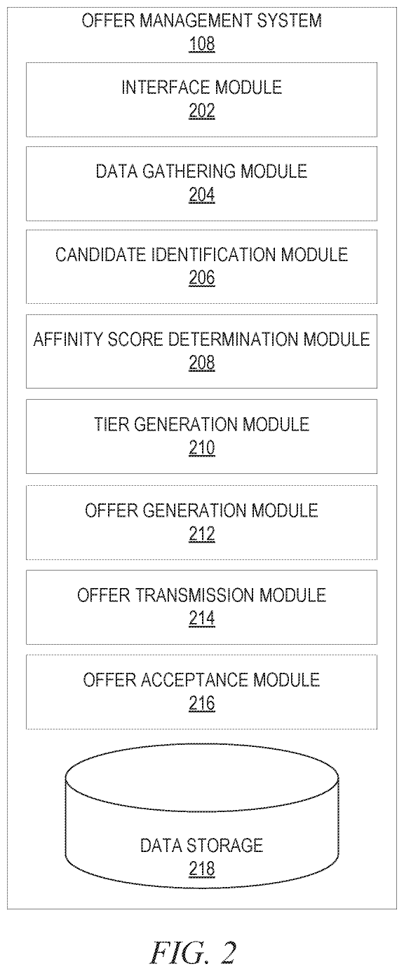

FIG. 2 is a block diagram of the offer management system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the draft completion system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the offer management system 108 and the online marketplace service 106.

As shown, the offer management system 108 includes, an interface module 202, a data gathering module 204, a candidate identification module 206, an affinity score determination module 208, a tier generation module 210, an offer generation module 212, an offer transmission module 214, an offer acceptance module 216, and a data storage 218.

The interface module 202 provides an offer management user interface that enables a user to utilize and configure the functionality of the offer management system 109. For example, the offer management user interface includes user interface element (e.g., buttons, text boxes, etc.) that allow the user to select configurations for items listed for sale by the user. This may include selecting which items for which the user would like to have automated offers transmitted to potential buyers, the prices included in the offers, the number of tiers of users to receive offers, etc. The data provided by the user using the offer management interface is stored in the data storage 218 and associated with the user's account. The stored data may be accessed by the other modules of the offer management system 108 for providing automated offer management of items listed for sale by the user.

The data gathering module 204 gathers data used by the various modules of the offer management system 108. For example, the data gathering module 204 gathers user profile data associated with the user accounts of the online marketplace service 106, listing data associated with listings posted on the online marketplace, search data, etc. The data may be gathered from the data storage 218. The user profile data may include data describing the user associated with the user profile, such as demographic data (e.g., user's age, sex, education level, income level, address, etc.). The data gathering module 204 may also gather affinity signal data that can be used to derive user interest in items and/or categories of items. The affinity signal data may include user provided interest data (e.g., user provided data indicating items/categories of items the user likes and/or dislikes). The affinity signal data may also include user interaction data describing actions performed by the user, such as search queries submitted by the user, items viewed by the user, items purchased by the user, items watched by the user, items the user has bid on, etc.

The candidate identification module 206 identifies a set of candidate users to receive an offer for an item listed on the online marketplace. The set of candidate users includes users that have created a user account with the online marketplace service 106 and that are determined to have some level of interest in purchasing the item listed for sale. For example, the candidate identification module 206 may identify users that have performed at least a threshold number of interactions with the listed item or listings for similar items. The interactions may include viewing a listing, making a bid, watching a listing, entering a search query that returned the listing as a search result, etc. As another example, the candidate identification module 206 may identify candidate users that provided preferences data indicating that the user is interested in the item, similar items and/or a category of items to which the item is a member.

The affinity score determination module 208 determines an affinity score for each candidate user. The affinity score is a score that indicates a user's estimated level of interest in purchasing an item listed for sale on the online marketplace. The affinity score determination module 208 determines the affinity score for each candidate user based on the affinity signals associated with the user. For example, the affinity score determination module 208 determines the affinity score for a user based on the number of interactions, types of interaction, etc., that the user has had with the listing or similar listings. The affinity score determination module 208 also determines the affinity score based on any user provided affinity signal that indicates whether the user likes or dislikes the item or similar items.

The affinity score determination module 208 may determine the affinity score for a user based on the number of determined interactions that a user has had with the item and/or similar items, as well as the different types of interactions performed by the user. For example, the affinity score determination module 208 may assign a relatively higher affinity score for a user that has performed a higher number of interaction and a relatively lower affinity score for a user that has performed a relatively lower number of interactions. The affinity score determination module 208 may also consider the type of interaction when calculating the affinity score. For example, interactions that are strong indicators of interest in the listing, such as the user having selected to watch the item, liked the item, made an offer on the item, etc., may have a relatively larger impact on the users affinity score than interactions that are a weaker indicator of interest in the listing, such as the user having indicating they like a general category to which the user item is a member. The affinity score determination module 208 may apply weights to each interaction based on the type of interaction such that interactions that are strong indicators of interest in the listing are given greater weight when calculating the affinity score.

In some embodiments, the affinity score determination module 208 applies weights based on when an interaction occurred. Interactions that occurred relatively recently may be a stronger indicator that a user is interested in purchasing an item as opposed to interactions that occurred relatively longer ago. Accordingly, the affinity score determination module 208 may apply a higher weight to interactions that were performed recently when calculating the affinity score. Likewise, the affinity score determination module 208 may apply a lower weight to interactions that occurred over a threshold period of time prior to calculation of the affinity score.

These are just a few examples of how the affinity score determination module 208 may calculate the affinity scores and are not meant to be limiting. The affinity score determination module 208 may use any of a variety of algorithms, weights, and affinity signals when calculating the affinity score and this disclosure anticipates all such embodiments.

The tier generation module 210 determines tiers of candidate users based on the affinity scores determined by the affinity score determination module 208. The generated tiers of candidate users indicate the estimated level of interest of the candidate users in purchasing a listed item. For example, the highest tier of candidate users includes the candidate users with the highest level of interest in purchasing the item, the second tier includes candidate users with a second highest level of interest in purchasing the listed item, and so on. In some embodiments, the candidate users in each tier of candidate users have a higher affinity score than candidate users in a lower tier of candidate users and a lower affinity score than candidate users in a higher tier of candidate users.

In some embodiments, the tier generation module 210 determines the tiers of candidate users based on a set of predetermined threshold values associated with the candidate user tiers. The threshold values indicate an affinity score range (e.g., a high threshold and low threshold) associated with each candidate user tier. The tier generation module 210 determines which affinity score range each candidate user's affinity score falls within and then assigns the candidate user to the corresponding candidate user tier.

In some embodiments, the tier generation module 210 evenly splits the candidate users into a predetermined number of candidate user tiers. For example, the tier generation module 210 determines the affinity score ranges for each candidate user tier such that the set of candidate users are evenly or near evenly splits amongst the candidate user tiers.

The offer generation module 212 generates offers for items listed for sale. The offer identifies the item and/or listing and includes a sale price at which the item may be purchased if the offer is accepted by the receiving user. The sale price may be a deviation from the listed sale price of the item on the online marketplace. For example, the sale price may be higher or lower than the listed sale price. The sale price included in the offer may be determined based on setting provided by the user associated with the listing. For example, the user may designate the deviated price or a percentage (e.g., 5%) which the price should be deviated either up or down.

The sale price included in the offer may also be based on the candidate user tier and/or specific candidate user to which the offer is being transmitted. For example, the sale price may be higher for candidate users determined to have a higher interest in purchasing the item as these users may need less added incentive to purchase the item. Accordingly, offers generated for a higher tier of candidate users or users with a higher affinity score may include a higher sale price than the sale price included in offers generated for a lower tier of candidate users or users with a lower affinity score. Alternatively, the sale price included in the offer may be lower for a higher tier of candidate users or users with a higher affinity score. This may provide a higher likelihood of a candidate user purchasing the item as the best price is offered to users with the highest interest in purchasing the item.

The offer may also include an expiration time indicating a time at which the offer expires. For example, the offer may include a day/time at which the offer expires. As another example, the offer may include a timer that indicates a remaining amount of time until the offer expires. Once the offer expires, the offer may no longer be accepted. Accordingly, the user that received the offer may not accept the offer to purchase the item at the offered sale price after the offer has expired.

In some embodiments, an offer may include multiple sale prices, each associated with a different expiration time. For example, the sale price may progressively increase as time passes, thereby incentivizing a user to accept the offer quickly to secure the best possible price for the item. In this type of embodiment, the offer may indicate that current sale price and an expiration time for the current sale price, along with a message indicating that the current sale price will increase after the expiration and/or that the current sale price is the lowest and that the price will progressively increase. The offer may automatically update the current sale price and expiration time as each expiration time is met.

Alternatively, the offer may simply list the sale prices and the corresponding expirations times. For example, the offer may indicate that an initial sale price is offered until a given expiration time, after which the sale price increases to another sale price until a subsequent expiration time, and so on.

The generated offer may also enable a user to accept the offer. For example, the offer may include a user interface element, such as a button, link, etc., that a user may select to accept the presented offer. Accepting the offer allows the user to purchase the item for the sale price listed in the offer. Additionally, the offer may allow the user to present a counter offer to the received offer. For example, the offer may include user interface elements, such as a button, text box, etc., that the user may use to enter a counter offer price at which the user would be willing to purchase the listed item. The entered counter offer may be presented to the seller to choose to accept or deny.

The offer transmission module 214 transmits the generated offers to candidate users. The offer transmission module 214 may transmit the offers using a variety of methods. For example, the offer transmission module 214 may transmit the offers as part of email messages, direct messages, in application messages, etc. Transmission of the offers may be based on a predetermined schedule. For example, the schedule may be a default schedule or based on a user provided settings.

The schedule indicates times at which an offer and subsequent offers are to be transmitted. The schedule may further indicate the set of candidate user and/or candidate user tier to receive the offer. In some embodiments, the schedule may be based on a time that the listing was posted to the online marketplace. For example, the schedule may indicate that the first offer be transmitted after a predetermined period of time has elapsed after the time the listing was initially posted without the listed item having been purchased. As an example, the schedule may dictate that the initial offer be transmitted 3 days after the listing is initially posted without the listed item having been posted.

The schedule may indicate regular intervals after the initial offer is transmitted at which subsequent offers are to be transmitted. For example, the schedule may dictate that subsequent offers should be sent every 2 days that an offer is not accepted. The intervals at which the subsequent offers are transmitted may coincide with the expiration time of the offers. For example, the subsequent offers may be transmitted as the previous offer expires. In some embodiment, the intervals may be varied, such that the period of time between subsequent offers increases or decreases. Alternatively, the interval may be static such that the period of time between subsequent offers is always the same.

The schedule may also dictate the order in which candidate users or tiers of candidate users are to receive offers. For example, the schedule may dictate that the initial offer be transmitted to highest tier of candidate users (e.g., the candidate users that have the highest level of interest in the item) and that subsequent offers be transmitted down the order of the candidate offer tiers such that the first subsequent offer is transmitted to the second tier of candidate users, followed by the third tier of candidate users, and so on. Alternatively, the schedule may dictate working up the tiers of candidate users such that the lowest tier of candidate users receives the initial offer and each subsequent offer is transmitted to the next highest candidate user tier. These are just two examples, however, and are not meant to be limiting. The schedule may dictate any order of candidate users and/or tiers of candidate users to receive offers and subsequent offers for a listing.

The offer acceptance module 216 manages acceptance of a transmitted offer for a listed item. Acceptance of an offer indicates that a candidate user that has received the offer has accepted to purchase the listed item for the price included in the offer. For example, the user may select the user interface element included in the offer to accept the offer, causing a message to be transmitted back to the offer management system. The message may include a unique identifier that identifies the candidate user that accepted the offer. The offer acceptance module 216 may provide the candidate user with an interface to complete the transaction, such as by entering their credit card information, shipping address, etc.

In embodiments in which an offer includes multiple sale prices, the offer acceptance module 216 may determine the sale price for an accepted offer. For example, the offer acceptance module 216 determines an amount of elapsed time after the offer was transmitted to the user and the corresponding price.

Once an offer has been accepted and/or the accepting user has completed payment for the item, the offer acceptance module 216 may transmit a notice to other candidate users that have received an unexpired offer for the item indicating that the item has been sold and that their offer is therefore revoked.

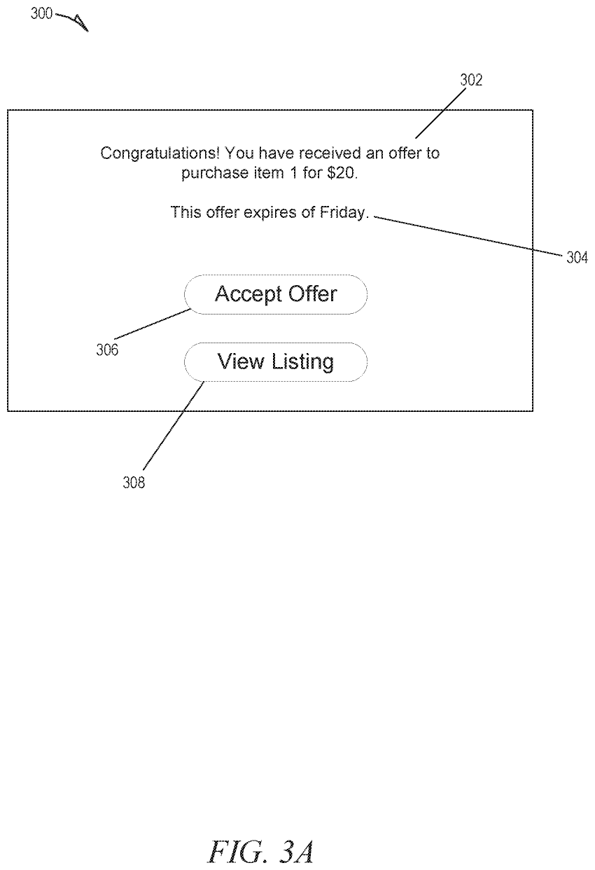

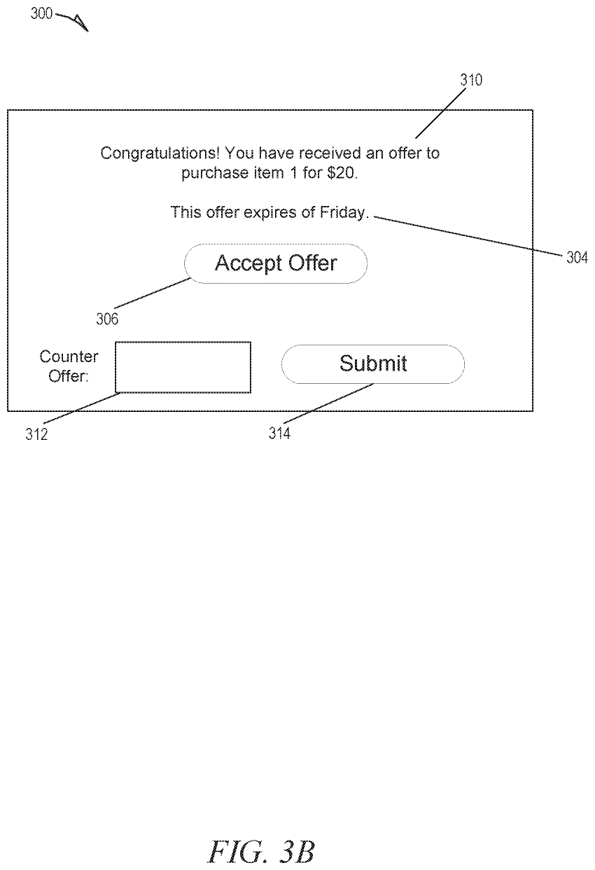

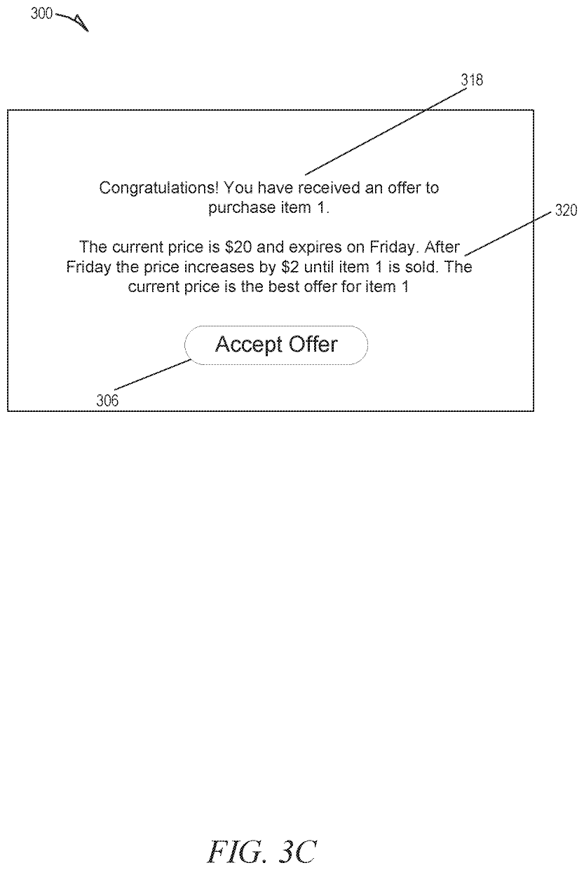

FIGS. 3A-3C show examples of offers that are automatically generated by the offer management system 108, according to some example embodiments. FIG. 3A shows an offer 300 for an item that is generated by the offer management system 108. As shown, the offer 300 includes text 302 notifying the user that the user has received an offer to purchase an item (e.g., item 1) for a given sale price (e.g., $20). The offer 300 further includes an expiration time 304 associated with the offer 300. As shown, the expiration time 304 indicates that the offer 300 expires on Friday. Accordingly, a user that received the offer 300 has until the expiration time 304 of Friday to accept the offer 300 and pay the sale price of $20 to purchase the item. In some embodiments, the offer 300 may also include data indicating a number of users that received the offer 300. This may motivate a buyer to make a purchase quickly.

The offer 300 includes an offer acceptance button 306 that the enables a user to accept the offer 300. For example, the user may actuate (e.g., click) the offer acceptance button 306 to accept the offer. In some embodiments, the offer 300 may include a coupon that can be applied at checkout. In this type of embodiment, a offer acceptance button 306 may not be needed.

The offer 300 further includes a view listing button 308 that enables a user to view the listing associates with the offer 300. For example, the user may actuate (e.g., click) the view listing button 308 to cause their client device 102 to present the listing. This may allow the user to view the item in greater detail to aide in determining whether to purchase the offered item.

FIG. 3B shows an offer 310 that enables a user to generate a counter offer. As shown, the offer 310 includes text 302 notifying the user that the user has received an offer to purchase an item (e.g., item 1) for a given sale price (e.g., $20), an expiration time 304, and an offer acceptance button 306. In contrast to the offer 300 shown in FIG. 3A, however, the offer 310 shown in FIG. 3B also includes a text field 312 and a submit button 314 that enable a user to generate and submit a counter offer to the offer 310. For example, the user may enter a sale price for the counter offer in the text field 312 and actuate (e.g., click) the submit button 314 to cause the counter offer including the entered sale price to be sent to the selling user.

FIG. 3C shows an offer 316 that includes multiple sale prices. As shown, the offer 316 includes text 318 notifying the user that the user has received an offer to purchase an item (e.g., item 1). The offer 316 also includes additional text 320 notifying the user of a current sale price and an expiration time for the current sale price. The additional text 320 also notifies the user that the current price increases incrementally by $2 every two days after the expiration date. The offer 316 also includes an offer acceptance button 306 that the user can use to accept the offer at the current sale prices. In some embodiments, the additional text 320 updates as the expiration time for the current offer expires. For example, the additional text 320 updates to identify the new current price as well as the next upcoming expiration time and what the offered price will be after the upcoming expiration time.

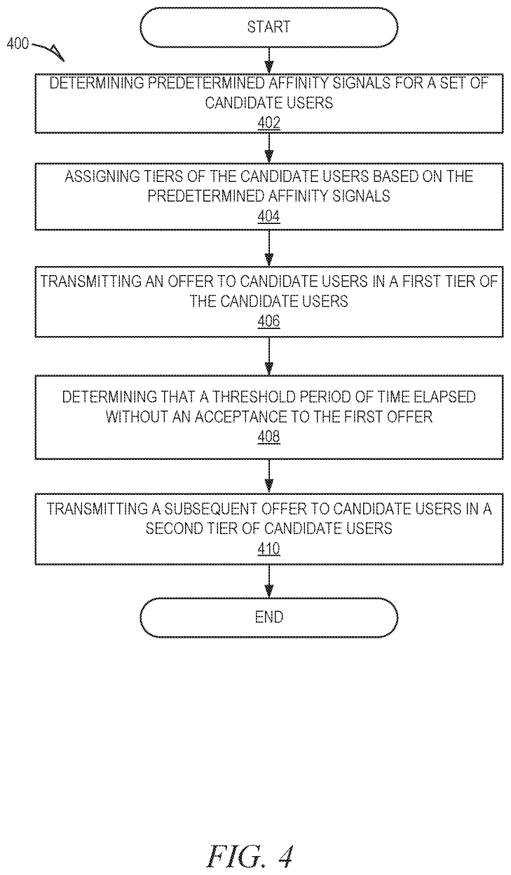

FIG. 4 is a flowchart showing an example method 400 of automatically generating offers for an item, according to certain example embodiments. The method 400 may be embodied in computer readable instructions for execution by one or more processors such that the operations of the method 400 may be performed in part or in whole by the offer management system 108; accordingly, the method 400 is described below by way of example with reference thereto. However, it shall be appreciated that at least some of the operations of the method 400 may be deployed on various other hardware configurations and the method 400 is not intended to be limited to the offer management system 108.

At operation 402, the affinity score determination module 208 determines predetermined affinity signals for a set of candidate users. Affinity signals are data that can be used to derive a user interest in an item and/or category of items. For example, affinity signals may include user provided interest data (e.g., user provided data indicating items/categories of items the user likes and/or dislikes) as well as user interaction data describing actions performed by the user, such as search queries submitted by the user, items viewed by the user, items purchased by the user, items watched by the user, items the user has bid on, etc.

The affinity score determination module 208 determines an affinity score for each candidate user based on the affinity signal. The affinity score is a score that indicates a user's estimated level of interest in purchasing an item listed for sale on the online marketplace. The affinity score determination module 208 determines the affinity score for each candidate user based on the affinity signals associated with the user. For example, the affinity score determination module 208 determines the affinity score for a user based on the number of interactions, types of interaction, etc., that the user has had with the listing or similar listings. The affinity score determination module 208 also determines the affinity score based on any user provided affinity signal that indicates whether the user likes or dislikes the item or similar items.

The affinity score determination module 208 may determine the affinity score for a user based on the number of determined interactions that a user has had with the item and/or similar items, as well as the different types of interactions performed by the user. For example, the affinity score determination module 208 may assign a relatively higher affinity score for a user that has performed a higher number of interaction and a relatively lower affinity score for a user that has performed a relatively lower number of interactions. The affinity score determination module 208 may also consider the type of interaction when calculating the affinity score. For example, interactions that are strong indicators of interest in the listing, such as the user having selected to watch the item, liked the item, made an offer on the item, etc., may have a relatively larger impact on the users affinity score than interactions that are a weaker indicator of interest in the listing, such as the user having indicating they like a general category to which the user item is a member. The affinity score determination module 208 may apply weights to each interaction based on the type of interaction such that interactions that are strong indicators of interest in the listing are given greater weight when calculating the affinity score.

In some embodiments, the affinity score determination module 208 applies weights based on when an interaction occurred. Interactions that occurred relatively recently may be a stronger indicator that a user is interested in purchasing an item as opposed to interactions that occurred relatively longer ago. Accordingly, the affinity score determination module 208 may apply a higher weight to interactions that were performed recently when calculating the affinity score. Likewise, the affinity score determination module 208 may apply a lower weight to interactions that occurred over a threshold period of time prior to calculation of the affinity score.

These are just a few examples of how the affinity score determination module 208 may calculate the affinity scores and are not meant to be limiting. The affinity score determination module 208 may use any of a variety of algorithms, weights, and affinity signals when calculating the affinity score and this disclosure anticipates all such embodiments.

At operation 404, the tier generation module 210 assigns tiers of the candidate users based on the predetermined affinity signals. The generated tiers of candidate users indicate the estimated level of interest of the candidate users in purchasing the listed item. For example, the highest tier of candidate users includes the candidate users with the highest level of interest in purchasing the item, the second tier includes candidate users with a second highest level of interest in purchasing the listed item, and so on. In some embodiments, the candidate users in each tier of candidate users have a higher affinity score than candidate users in a lower tier of candidate users and a lower affinity score than candidate users in a higher tier of candidate users.

In some embodiments, the tier generation module 210 determines the tiers of candidate users based on a set of predetermined threshold values associated with the candidate user tiers. The threshold values indicate an affinity score range (e.g., a high threshold and low threshold) associated with each candidate user tier. The tier generation module 210 determines which affinity score range each candidate user's affinity score falls within and then assigns the candidate user to the corresponding candidate user tier.

In some embodiments, the tier generation module 210 evenly splits the candidate users into a predetermined number of candidate user tiers. For example, the tier generation module 210 determines the affinity score ranges for each candidate user tier such that the set of candidate users are evenly or near evenly splits amongst the candidate user tiers.

At operation 406, the offer transmission module 214 transmits an offer to candidate users in a first tier of the candidate users. The offer is an offer to purchase the listed item for a sale price that is a deviation from the sale price included in the listing for the item on the online marketplace. For example, the deviated price may be higher or lower than the sale price included in the listing for the item. The offer may include an expiration time for the offer, which sets a deadline by which the receiving user may accept the offer and purchase the listed item for the sale price included in the offer.

The offer transmission module 214 may transmit the offers using a variety of methods. For example, the offer transmission module 214 may transmit the offers as part of email messages, direct messages, in application messages, etc.

Transmission of the offers may be based on a predetermined schedule. For example, the schedule may be a default schedule or based on a user provided settings. The schedule indicates times at which an initial offer and subsequent offers are to be transmitted. The schedule may further indicate the set of candidate user and/or candidate user tier to receive the offer. In some embodiments, the schedule may be based on a time that the listing was posted to the online marketplace. For example, the schedule may indicate that the first offer be transmitted after a predetermined period of time has elapsed after the time the listing was initially posted without the listed item having been purchased. As an example, the schedule may dictate that the initial offer be transmitted 3 days after the listing is initially posted without the listed item having been posted.

At operation 408, the offer transmission module 214 determines that a threshold period of time elapsed without an acceptance to the first offer. The threshold period of time may be dictated by the schedule and/or based on the expiration time associated with the initial offer transmitted to the first tier of candidate users.

At operation 410, the offer transmission module 214 transmits a subsequent offer to candidate users in a second tier of candidate users. The subsequent offer may include a sale price that is different than the sale price included in the first offer. For example, the sale price included in the subsequent offer may be higher or lower than the sale price included in the initial offer that was transmitted to users in the first tier of candidate users.

The process may continue for subsequent tiers of candidate users. For example, in the event that a threshold period of time elapses without the second offer being accepted, the offer transmission module 214 may transmit another subsequent offer to candidate users in the third tier of candidate users.

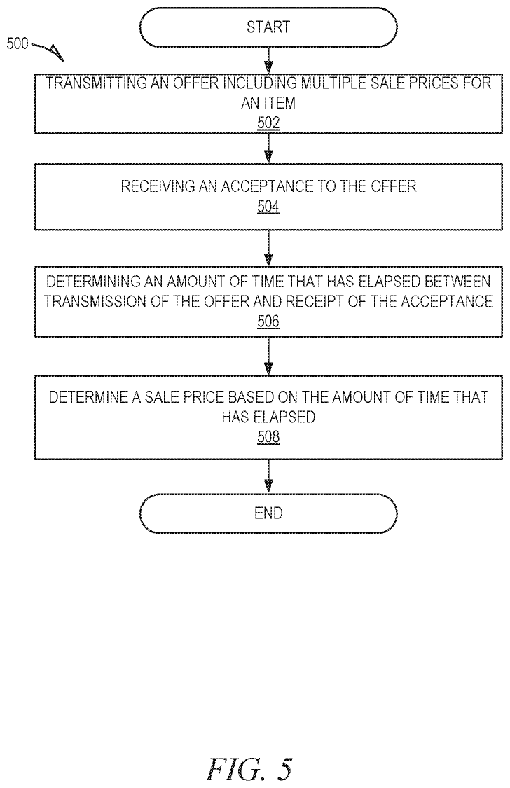

FIG. 5 is a flowchart showing an example method 500 of generating and transmitting offers including multiple sale prices, according to certain example embodiments. The method 500 may be embodied in computer readable instructions for execution by one or more processors such that the operations of the method 500 may be performed in part or in whole by the offer management system 108; accordingly, the method 500 is described below by way of example with reference thereto. However, it shall be appreciated that at least some of the operations of the method 500 may be deployed on various other hardware configurations and the method 500 is not intended to be limited to the offer management system 108.

At operation 502, the offer transmission module 214 transmits an offer including multiple sale prices for an item. The offer may be transmitted to a single candidate user or a group of candidate users, such as a group of candidate users in a tier of candidate users. The offer includes multiple sale prices, each associated with a different expiration time. For example, the sale price may progressively increase as time passes, thereby incentivizing a user to accept the offer quickly to secure the best possible price for the item. In this type of embodiment, the offer may indicate the current sale price and an expiration time for the current sale price, along with a message indicating that the current sale price will increase after the expiration and/or that the current sale price is the lowest and that the price will progressively increase. Alternatively, the offer may simply list the sale prices and the corresponding expirations times. For example, the offer may indicate that an initial sale price is offered until a given expiration time, after which the sale price increases to another sale price until a subsequent expiration time, and so on.

At operation 504, the offer acceptance module 216 receives an acceptance to the offer. The acceptance indicates that a user that received the offer has selected to accept the offer and purchase the listed item at the current sale price.

As explained above, the current price included in the offer is variable based on time. Accordingly, at operation 506, the offer acceptance module 216 determines an amount of time that has elapses between transmission of the offer and receipt of the acceptance, and at operation 508, the offer acceptance module 216 determines the current sale price based on the amount of time that has elapsed.

### Software Architecture

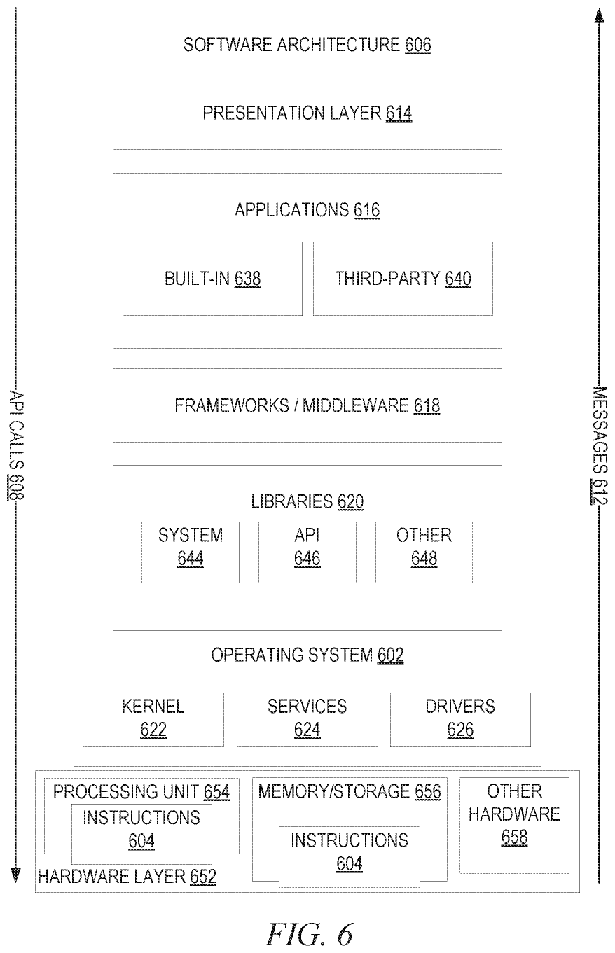

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke Application Programming Interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 704 (sometimes referred to as “cores”) that may execute instructions 710 contemporaneously.

What is claimed is:

1. A method comprising:
determining, for each candidate user from a set of candidate users, predetermined affinity signals indicating the respective candidate user's level of interest in purchasing an item listed for sale on an online marketplace, the item listed for sale having a sale price;
determining, based on the affinity signals, a first tier of candidate users and a second tier of candidate users, the first tier of candidate users including a first subset of the set of candidate users and the second tier of candidate users including a second subset of the set of candidate users; and
in response to determining that a threshold period of time has elapsed, transmitting to candidate users in the first tier of candidate users, a first offer in relation to the item listed for sale, the first offer including a first offer price that is a first deviation from the sale price of the item.

2. The method of claim 1, wherein determining the first tier of candidate users and the second tier of candidate users comprises:
determining, for each candidate user, an affinity score based on the predetermined affinity signals for the respective candidate user, yielding a set of affinity scores; and
ranking the set of candidate users based on the set of affinity scores; and determining the first tier of candidate users and the second tier of candidate users based on the ranking.

3. The method of claim 1, further comprising:
in response to determining that a second threshold period of time has elapsed without receiving an acceptance to the first offer, transmitting to candidate users in the second tier of candidate users, a second offer in relation to the item listed for sale, the second offer including a second offer price that is a second deviation from the sale price of the item.

4. The method of claim 3, wherein the second deviation from the sale price of the item is greater than the first deviation from the sale price of the item.

5. The method of claim 3, wherein the second deviation from the sale price of the item is less than the first deviation from the sale price of the item.

6. The method of claim 1, further comprising:
identifying users of the online marketplace that have previous interactions with a listing on the online marketplace for the listed item, yielding the set of candidate users.

7. The method of claim 6, wherein the previous interactions include at least one of making an offer to purchase the item, selecting to watch the item and viewing the item.

8. The method of claim 3, wherein the second offer is also transmitted to candidate users in the first tier of candidate users.

9. A system comprising:
one or more computer processors; and
one or more computer-readable mediums storing instructions that, when executed by the one or more computer processors, cause the system to perform operations comprising:
determining, for each candidate user from a set of candidate users,
predetermined affinity signals indicating the respective candidate user's level of interest in purchasing an item listed for sale on an online marketplace, the item listed for sale having a sale price;
determining, based on the affinity signals, a first tier of candidate users and a second tier of candidate users, the first tier of candidate users including a first subset of the set of candidate users and the second tier of candidate users including a second subset of the set of candidate users; and
in response to determining that a threshold period of time has elapsed, transmitting to candidate users in the first tier of candidate users, a first offer in relation to the item listed for sale, the first offer including a first offer price that is a first deviation from the sale price of the item.

10. The system of claim 9, wherein determining the first tier of candidate users and the second tier of candidate users comprises:
determining, for each candidate user, an affinity score based on the predetermined affinity signals for the respective candidate user, yielding a set of affinity scores; and
ranking the set of candidate users based on the set of affinity scores; and determining the first tier of candidate users and the second tier of candidate users based on the ranking.

11. The system of claim 9, the operations further comprising:
in response to determining that a second threshold period of time has elapsed without receiving an acceptance to the first offer, transmitting to candidate users in the second tier of candidate users, a second offer in relation to the item listed for sale, the second offer including a second offer price that is a second deviation from the sale price of the item.

12. The system of claim 11, wherein the second deviation from the sale price of the item is greater than the first deviation from the sale price of the item.

13. The system of claim 11, wherein the second deviation from the sale price of the item is less than the first deviation from the sale price of the item.

14. The system of claim 9, the operations further comprising:
identifying users of the online marketplace that have previous interactions with a listing on the online marketplace for the listed item, yielding the set of candidate users.

15. The system of claim 14, wherein the previous interactions include at least one of making an offer to purchase the item, selecting to watch the item and viewing the item.

16. The system of claim 11, wherein the second offer is also transmitted to candidate users in the first tier of candidate users.

17. A non-transitory computer-readable medium storing instructions that, when executed by one or more computer processors of a computing system, cause the computing system to perform operations comprising:
transmitting, to at least a first user, a first offer in relation to an item listed for sale, the first offer including a first offer price that is a first deviation from the sale price of the item and a second offer price that is a second deviation from the sale price of the item, the first offer price being valid during a first time period and the second offer price being valid during a second time period that is subsequent to the second time period, wherein the second offer price is higher than the first offer price.

18. The non-transitory computer-readable medium of claim 17, wherein the second offer price is one of a plurality of successive offer prices presented at regular intervals after the first time period, each successive offer price increasing by a predetermined amount.

19. The non-transitory computer-readable medium of claim 18, wherein upon presenting the first offer, a message is presented stating that the first offer is a lowest offer that will only be valid during the first time period a d that each successive offer price will be higher than the first offer.

20. The non-transitory computer-readable medium of claim 18, wherein the predetermined amount is based on predetermined affinity signals indicating the respective first user's level of interest in purchasing the item listed for sale.
